(19) United States
(12) Patent Application Publication
(10) Pub. No.: US 2019/0027139 A1
(43) Pub. Date: Jan. 24, 2019

(54) DIGITAL VOICE ASSISTANT OPERATION SYSTEM

(71) Applicant: Primax Electronics Ltd., Taipei (TW)

(72) Inventors: Chia-Shyang Hsu, Taipei (TW); Pei-Luan Yen, Taipei (TW); Wen-Shih Lee, Taipei (TW); Tsung-Chieh Lee, Taipei (TW)

(21) Appl. No.: 15/812,870

(22) Filed: Nov. 14, 2017

(30) Foreign Application Priority Data
Jul. 21, 2017 (TW) 106124633

(51) Int. Cl. G10L 15/22; G10L 15/08; G10L 15/30

(52) U.S. Cl. CPC G10L 15/22; G10L 15/08; G10L 2015/088; G10L 2015/223; G10L 15/30

(57) ABSTRACT

A digital voice assistant operation system includes an access point, an electronic device, an audio device and a digital voice assistant module. The access point is in communication with a voice recognition module through network connection. The electronic device is in communication with the access point through network connection. After the user provides a voice command to the audio device, the voice command is transmitted to the voice recognition module through the audio device, the digital voice assistant module and the access point. After the voice recognition module recognizes the voice command, an operating signal corresponding to the voice command is outputted from the voice recognition module to the electronic device. Consequently, the electronic device performs an operation according to the operating signal.

### FIELD OF THE INVENTION

The present invention relates to an operation system, and more particularly to a digital voice assistant operation system.

### BACKGROUND OF THE INVENTION

Recently, an electronic device is equipped with a digital voice assistant (DVA) module for allowing the user to issue a voice command to the electronic device in a voice transmission manner. After the electronic device recognizes the content of the voice command, the electronic device performs a task corresponding to the voice command. Take a smart phone for example. When the digital voice assistant module of the smart phone is enabled and the user says “call father” to the smart phone, the content of the voice command received by the digital voice assistant module is “call father”. After the digital voice assistant module recognizes and understands the content of the voice command, the digital voice assistant module controls the smart phone to perform the task of calling father. Accordingly, it is not necessary to use the hand of the user to operate the smart phone to perform the task of calling father. In case that the user is not willing to use the hand to operate the smart phone, the digital voice assistant module can be used to assist the user in operating the smart phone.

With the increasing development of the digital voice assistant technology, the digital voice assistant module is usually produced as a standalone machine and applied to the digital family. Consequently, a digital voice assistant operation system has been disclosed. FIG. 1 is a schematic functional block diagram illustrating the architecture of a conventional digital voice assistant operation system. The conventional digital voice assistant operation system 1 is in communication with a voice recognition module 10 through network connection. The voice recognition module 10 is installed in a server of the internet. As shown in FIG. 1, the conventional digital voice assistant operation system 1 comprises a first digital voice assistant module 11, a second digital voice assistant module 12, an electronic device 13 and an access point (AP) 14. For example, the first digital voice assistant module 11 and the access point 14 are installed in the living room, the second digital voice assistant module 12 is installed in the bedroom, and the electronic device 13 is installed in the kitchen. The first digital voice assistant module 11 is in communication with the access point 14 in a wired transmission manner or a wireless transmission manner. The second digital voice assistant module 12 and the electronic device 13 are in communication with the access point 14 in a wireless transmission manner. The access point 14 is in communication with a voice recognition module 10 through network connection. For example, the voice recognition module 10 is an artificial intelligence module or an application program with the voice recognition function. The electronic device 13 is an intelligent air conditioner. The access point 14 is a network router or a network base station.

Please refer to FIG. 1 again. The first digital voice assistant module 11 comprises a first network transmission module 111, a first control unit 112, a first microphone 113 and a first voice recognition unit 114. The first network transmission module 111 is in communication with the access point 14 in a wired transmission manner or a wireless transmission manner. The first control unit 112 is connected with the first network transmission module 111, the first microphone 113 and the first voice recognition unit 114. The first microphone 113 is used for receiving a voice command and a wake-up command from the user. The first voice recognition unit 114 is connected with the first microphone 113 for recognizing the wake-up command from the user. A default wake-up command C1 “Wake Up” is stored in the first voice recognition unit 114. The second digital voice assistant module 12 comprises a second network transmission module 121, a second control unit 122, a second microphone 123 and a second voice recognition unit 124. The functions of the components of the second digital voice assistant module 12 are similar to those of the first digital voice assistant module 11, and are not redundantly described herein.

The operations of the conventional digital voice assistant operation system 1 will be described as follows. When the user W in the living room says the wake-up command C1 “Wake Up” to the first digital voice assistant module 11, the first microphone 113 receives the wake-up command C1 and transmits the wake-up command C1 to the first voice recognition unit 114. Meanwhile, the first voice recognition unit 114 recognizes that the wake-up command C1 matches the default wake-up command “Wake Up”. After the recognition is completed, the first voice recognition unit 114 judges that the voice “Wake Up” is the wake-up command. Consequently, the first digital voice assistant module 11 is wakened up from the hibernation mode, and the first digital voice assistant module 11 is enabled. Then, the user W says a voice command C2 “Turn on air conditioner” to the first digital voice assistant module 11. Consequently, the first microphone 113 receives the voice command C2, and the first voice recognition unit 114 recognizes the voice command C2 “Turn on air conditioner”. Since the first voice recognition unit 114 cannot search the corresponding default command, the first voice recognition unit 114 is unable to recognize the voice command C2. Since the voice command C2 is not recognized by the first voice recognition unit 114, the voice command C2 is outputted and transmitted from the first control unit 112 to the voice recognition module 10 through the access point 14.

After the voice recognition module 10 recognizes that the content of the voice command C2 is “Turn on air conditioner”, the voice recognition module 10 judges whether the voice recognition module 10 has a default operating signal corresponding to the voice command “Turn on air conditioner”. If the voice recognition module 10 searches the corresponding operating signal S, the voice recognition module 10 transmits the operating signal S to the electronic device 13 in the kitchen through the access point 14. Consequently, the electronic device 13 is operated according to the operating signal S. That is, the electronic device 13 is operated to turn on the air conditioner. As mentioned above, the user W in the living room can operate the electronic device 13 in the kitchen through the first digital voice assistant module 11. Similarly, the user W in the bedroom can perform the identical operations through the second digital voice assistant module 12 in the bedroom. That is, the second digital voice assistant module 12 and the voice recognition module 10 perform the same operations to turn on the electronic device 13 in the kitchen. The operations of the second digital voice assistant module 12 are similar to those of the first digital voice assistant module 11, and are not redundantly described herein.

Although the conventional digital voice assistant operation system 1 allows the user to operate the electronic device in a voice transmission manner, there are still some drawbacks. For example, one digital voice assistant module is needed for a different place. That is, more digital voice assistant modules are needed to provide a more convenient digital voice assistant operation system. Since the digital voice assistant module is not cost-effective, it is difficult to popularize the conventional digital voice assistant operation system.

Therefore, there is a need of providing a digital voice assistant operation system with cost-effectiveness.

### SUMMARY OF THE INVENTION

The present invention provides a digital voice assistant operation system with cost-effectiveness.

In accordance with an aspect of the present invention, there is provided a digital voice assistant operation system. The digital voice assistant operation system is in communication with a voice recognition module through network connection. The digital voice assistant operation system includes an access point, an electronic device, an audio device and a digital voice assistant module. The access point is in communication with the voice recognition module through network connection. The electronic device is in communication with the access point through network connection. The audio device receives a first voice command and outputs the first voice command. The digital voice assistant module is in wireless communication with the audio device and in communication with the access point through network connection. The digital voice assistant module includes a first wireless transmission module, a network transmission module and a control unit. The first wireless transmission module is in wireless communication with the audio device, and receives the first voice command. The network transmission module in communication with the access point through network connection, and transmits the first voice command. The control unit is connected with the network transmission module. After the control unit receives the first voice command, the control unit controls the network transmission module to transmit the first voice command, and the control unit transmits the first voice command to the voice recognition module through the access point. After the voice recognition module recognizes the first voice command, a first operating signal corresponding to the first voice command is outputted from the voice recognition module to the electronic device through the access point, so that the electronic device performs an operation according to the first operating signal.

In an embodiment, after a third microphone of the digital voice assistant module receives a third voice command, the control unit transmits the third voice command to the voice recognition module through the network transmission module. After the voice recognition module recognizes the third voice command, a third operating signal corresponding to the third voice command is outputted from the voice recognition module to the digital voice assistant module and the control unit issues a call request to the audio device according to the third operating signal. After the first wireless transmission module receives a response signal from the audio device, the control unit establishes call communication between the digital voice assistant module and the audio device according to the response signal.

In an embodiment, after a second microphone of the audio device receives a third voice command, the second wireless transmission module transmits the third voice command to the first wireless transmission module in a wireless transmission manner, and the control unit transmits the third voice command to the voice recognition module through the network transmission module. After the voice recognition module recognizes the third voice command, a third operating signal corresponding to the third voice command is outputted from the voice recognition module to the digital voice assistant module.

In an embodiment, the control unit controls a second speaker of the digital voice assistant module to generate a notification sound according to the third operating signal. After the third microphone receives a response command and the voice recognition unit recognizes the response command, the voice recognition unit generates a response signal corresponding to the response command, and the control unit establishes call communication between the digital voice assistant module and the audio device according to the response signal.

In accordance with another aspect of the present invention, there is provided a digital voice assistant operation system. The digital voice assistant operation system is in communication with a voice recognition module through network connection. The digital voice assistant operation system includes an access point, a first audio device, a digital voice assistant module and a second audio device. The access point is in communication with the voice recognition module through network connection. The first audio device receives a voice command and outputs the first voice command. The digital voice assistant module is in wireless communication with the first audio device and in communication with the access point through network connection. The digital voice assistant module includes a first wireless transmission module, a network transmission module and a control unit. The first wireless transmission module is in wireless communication with the first audio device, and receives the first voice command. The network transmission module is in communication with the access point through network connection, and transmits the first voice command. The voice command is transmitted to the voice recognition module through the access point. After the voice recognition module recognizes the voice command, an operating signal corresponding to the voice command is outputted from the voice recognition module. The control unit is connected with the network transmission module. The control unit issues a call request according to the operating signal. The second audio device is in wireless communication with the first wireless transmission module. The second audio device receives the call request and generates a response signal corresponding to the call request. The control unit establishes call communication between the first audio device and the second audio device according to the response signal.

In an embodiment, the first audio device includes a first microphone, a first voice recognition unit, a second microphone and a second wireless transmission module. The first microphone receives a wake-up command. The first voice recognition unit is connected with the first microphone to recognize the wake-up command. After the first voice recognition unit recognizes the wake-up command, the first audio device is wakened up from a hibernation mode by the first recognition unit. The second microphone receives the voice command. The second wireless transmission module is connected with the second microphone and in wireless communication with the first wireless transmission module and the second audio device. The voice command is wirelessly transmitted from the second wireless transmission module.

In an embodiment, the second audio device includes a third microphone, a speaker, a second voice recognition unit and a third wireless transmission module. The third microphone receives a response command corresponding to the call request. After the third microphone receives the call request, the speaker outputs a notification sound corresponding to the call request. The second voice recognition unit is connected with the third microphone to recognize the response command. After the second voice recognition unit recognizes the response command, the second audio device generates the response signal corresponding to the response command. The third wireless transmission module is connected with the speaker and in wireless communication with the first wireless transmission module and the first audio device. The call request and the response command are wirelessly transmitted from the third wireless transmission module.

From the above descriptions, the present invention provides a digital voice assistant operation system. The digital voice assistant operation system can be applied to a digital family. In accordance with the present invention, plural audio devices are installed in different rooms and the plural audio devices are in wireless communication with a digital voice assistant module. The user may provide the voice command to the audio device in a voice transmission manner. According to the voice command, the audio device and the digital voice assistant module are in wireless communication with each other to perform the associated operations. Consequently, the electronic device in a different room can be controlled, or the plural audio devices in different rooms can make voice calls between each other.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating the architecture of a conventional digital voice assistant operation system;

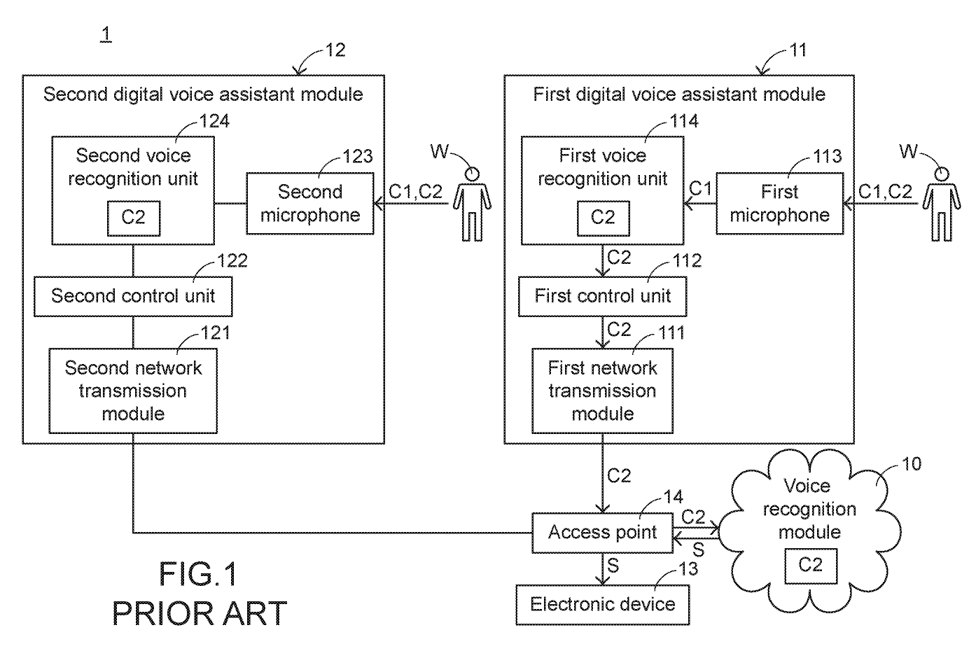

FIG. 2 is a schematic functional block diagram illustrating the architecture of a digital voice assistant operation system according to a first embodiment of the present invention; and

FIG. 3 is a schematic functional block diagram illustrating the architecture of a digital voice assistant operation system according to a second embodiment of the present invention.

### DETAILED DESCRIPTION OF THE PREFERRED EMBODIMENT

For solving the drawbacks of the conventional technologies, the present invention provides a digital voice assistant operation system.

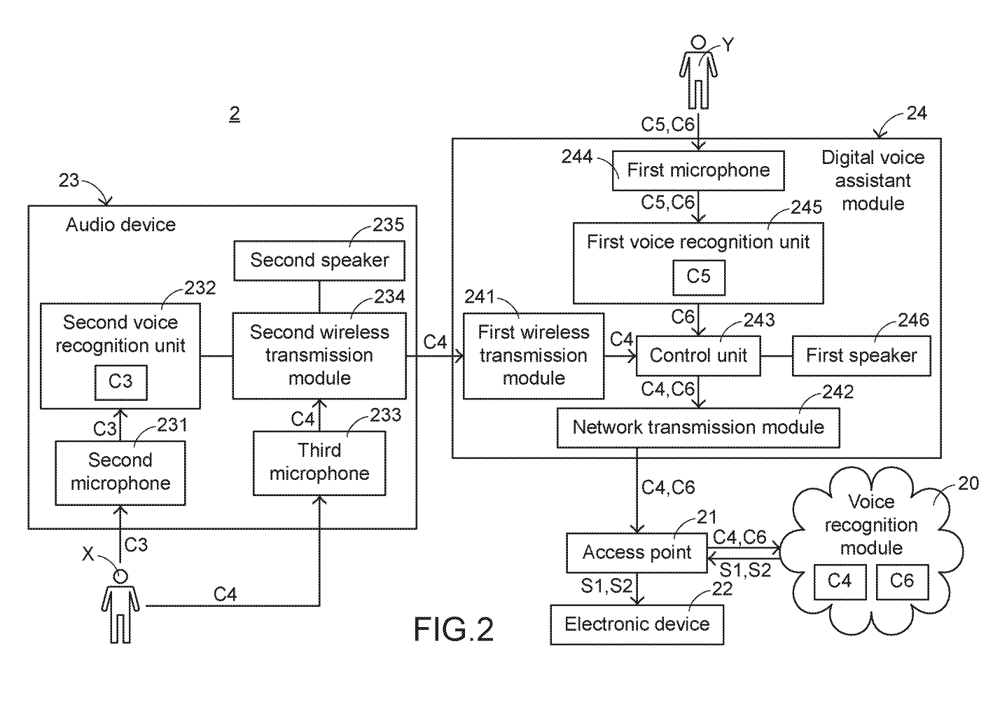

FIG. 2 is a schematic functional block diagram illustrating the architecture of a digital voice assistant operation system according to a first embodiment of the present invention. As shown in FIG. 2, the digital voice assistant operation system 2 comprises an access point 21, an electronic device 22, an audio device 23 and a digital voice assistant module 24. The access point 21 is in communication with a voice recognition module 20 through network connection. The voice recognition module 20 is installed in a server of the internet. The electronic device 22 is in communication with the access point 21 through network connection. The audio device 23 is in communication with the digital voice assistant module 24 in a wireless transmission manner. The audio device 23 is used for receiving a voice command from the user and transmitting the voice command to the digital voice assistant module 24. The digital voice assistant module 24 is in communication with the audio device 23 in a wireless transmission manner and in communication with the access point 21 through network connection. For example, the access point 21 and the digital voice assistant module 24 are installed in the living room, the access point 21 is a network router or a network base station, the audio device 23 is installed in the bedroom, and the electronic device 22 is an intelligent air conditioner that is installed in the kitchen.

The digital voice assistant module 24 comprises a first wireless transmission module 241, a network transmission module 242, a control unit 243, a first microphone 244, a first voice recognition unit 245 and a first speaker 246. The first wireless transmission module 241 is connected with the control unit 243 and in communication with the audio device 23 in a wireless transmission manner. The first wireless transmission module 241 is used for receiving a first wake-up command C3 and a first voice command C4 from the audio device 23. The network transmission module 242 is connected with the control unit 243 and in communication with the access point 21 through network connection. The network transmission module 242 is used for transmitting the first voice command C4 in a network transmission manner. The control unit 243 is further connected with the first voice recognition unit 245. After the control unit 243 receives the first voice command C4, the control unit 243 controls the first wireless transmission module 241 to transmit the first voice command C4. Moreover, the first voice command C4 is transmitted to the voice recognition module 20 through the access point 21 in a network transmission manner. The first microphone 244 is connected with the first voice recognition unit 245. The first microphone 244 is used for receiving a second wake-up command C5 and a second voice command C6 from the user. The first voice recognition unit 245 is used for recognizing the second wake-up command C5. After the second wake-up command C5 is recognized, the digital voice assistant module 24 is wakened up from the hibernation mode, and the digital voice assistant module 24 is enabled. A default second wake-up command C5 “Wake Up” is stored in the first voice recognition unit 245. The example of the default second wake-up command is presented herein for purpose of illustration and description only. The first speaker 246 is connected with the control unit 243. The first speaker 246 is used for playing music or outputting a feedback prompt sound. The content of the feedback prompt sound will be described later.

In an embodiment, the control unit 243 is a microprocessor, and the first voice recognition unit 245 is a voice recognition chip. Moreover, the access point 21 provides a wireless network connecting function to the network transmission module 242. For example, the access point 21 is in communication with the network transmission module 242 in a wireless transmission manner (e.g., Wi-Fi). The above examples are presented herein for purpose of illustration and description only. In another embodiment, the network transmission module is in communication with the access point in a wired transmission manner (e.g., through a network line).

The audio device 23 comprises a second microphone 231, a second voice recognition unit 232, a third microphone 233, a second wireless transmission module 234 and a second speaker 235. The second microphone 231 is connected with the second voice recognition unit 232. The second microphone 231 is used for receiving a first wake-up command C3 from the user. The second voice recognition unit 232 is connected with the second microphone 231 and the second wireless transmission module 234. The second voice recognition unit 232 is used for recognizing the received first wake-up command C3. After the first wake-up command C3 is recognized, the audio device 23 is wakened up from the hibernation mode, and the audio device 23 is enabled. A default first wake-up command C3 “Wake Up” is stored in the second voice recognition unit 232. The example of the default first wake-up command is presented herein for purpose of illustration and description only. The third microphone 233 is connected with the second wireless transmission module 234. The third microphone 233 is used for receiving a first voice command C4 from the user. The second wireless transmission module 234 is in communication with the first wireless transmission module 241 in a wireless transmission manner. The first voice command C4 is wirelessly transmitted from the second wireless transmission module 234 to the first wireless transmission module 241. The second speaker 235 is connected with the second wireless transmission module 234. Moreover, the second speaker 235 is used for outputting a feedback prompt sound.

In an embodiment, the second voice recognition unit 232 is a voice recognition chip, and the second wireless transmission module 234 is a system on chip (SOC). Moreover, the first wireless transmission module 241 of the digital voice assistant module 24 and the second wireless transmission module 234 of the audio device 23 are in wireless communication with each other through a digital enhanced cordless telecommunications (DECT) technology.

The operations of the digital voice assistant operation system 2 of the present invention will be described as follows. If the first user X in the bedroom intends to turn on the electronic device 22 in the kitchen, the first user 2 can use the digital voice assistant operation system 2 to achieve this purpose. Firstly, the digital voice assistant module 24 is in the hibernation mode, and the first microphone 244 and the first voice recognition unit 245 are in a power-saving state. Similarly, the audio device 23 is in the hibernation mode, and the second microphone 231, the second voice recognition unit 232 and the third microphone 233 are in the power-saving state. When the first user X says the first wake-up command C3 “Wake Up” to the audio device 23, the second microphone 231 receives the first wake-up command C3 and transmits the first wake-up command C3 to the second voice recognition unit 232. Meanwhile, the second voice recognition unit 232 recognizes that the first wake-up command C3 matches the default first wake-up command “Wake Up”. After the recognition is completed, the second voice recognition unit 232 judges that the voice “Wake Up” from the first user X is the first wake-up command C3. Consequently, the audio device 23 is wakened up from the hibernation mode, and the audio device 23 is enabled.

When the first user X says the first wake-up command C3 “Wake Up” to the audio device 23, the third microphone 233 also receives the first wake-up command C3. Since the second wireless transmission module 234 connected with the third microphone 233 is still in the hibernation mode, the second wireless transmission module 234 does not transmit the first wake-up command C3 at this moment. Since the first wake-up command C3 received by the third microphone 233 does not work, the first wake-up command C3 received by the third microphone 233 is not shown in the drawing.

After the audio device 23 is enabled, the first user X may say the first voice command C4 “Turn on air conditioner” to the audio device 23. Consequently, the first voice command C4 is received by both of the second microphone 231 and the third microphone 233. The second voice recognition unit 232 can receive the first voice command C4 through the second microphone 231. However, the second voice recognition unit 232 is only able to recognize the first wake-up command C3, but unable to recognize the content of the first voice command C4. Since the first voice command C4 received by the second microphone 231 does not work, the first voice command C4 received by the second microphone 231 is not shown in the drawing. After the second wireless transmission module 234 of the audio device 23 is wakened up, the first voice command C4 can be transmitted to the second wireless transmission module 234 through the third microphone 233.

After the second wireless transmission module 234 receives the first voice command C4, the second wireless transmission module 234 is in wireless communication with the first wireless transmission module 241 of the digital voice assistant module 24. Consequently, the subsequent wireless transmission can be maintained. Meanwhile, the digital voice assistant module 24 is wakened up by the first wireless transmission module 241. Then, the first voice command C4 is transmitted from the second wireless transmission module 234 to the first wireless transmission module 241 in a wireless transmission manner. After the first voice command C4 is received by the first wireless transmission module 241, the first voice command C4 is transmitted from the control unit 243 to the voice recognition module 20 of the internet through the access point 21 in a network transmission manner.

After the voice recognition module 20 receives the first voice command C4, the voice recognition module 20 judges whether the voice recognition module 20 has a default operating signal corresponding to the first voice command C4 “Turn on air conditioner”. If the voice recognition module 20 searches a corresponding first operating signal S1, the first operating signal S1 corresponding to the first voice command C4 is transmitted from the voice recognition module 20 to the access point 21, and the first operating signal S1 is transmitted from the access point 21 to the electronic device 22 in the kitchen. Consequently, the electronic device 22 is operated according to the first operating signal S1. That is, the electronic device 22 is operated to turn on the air conditioner. According to the technology of the present invention, the first user X in the bedroom can operate the electronic device 22 in the kitchen through the audio device 23 and the digital voice assistant module 24.

Moreover, the second user Y in the living room may operate the electronic device 22 in the kitchen through the digital voice assistant module 24 in the living room. When the second user Y says the second wake-up command C5 “Wake Up” to the digital voice assistant module 24, the first microphone 244 also receives the second wake-up command C5. Moreover, the second wake-up command C5 is transmitted from the first microphone 244 to the first voice recognition unit 245. Meanwhile, the first voice recognition unit 245 recognizes that the second wake-up command C5 matches the default second wake-up command “Wake Up”. After the recognition is completed, the first voice recognition unit 245 judges that the voice “Wake Up” from the second user Y is the second wake-up command C5. Consequently, the digital voice assistant module 24 is wakened up from the hibernation mode, and the digital voice assistant module 24 is enabled.

After the digital voice assistant module 24 is enabled, the second user Y may say the second voice command C6 “Turn on air conditioner” to the digital voice assistant module 24. Consequently, the second voice command C6 is received by the first microphone 244. The second voice command C6 is transmitted from the first microphone 244 to the first voice recognition unit 245. Since the first voice recognition unit 245 cannot search the second voice command C6, the second voice command C6 is transmitted from the control unit 243 to the network transmission module 242. In addition, the second voice command C6 is transmitted to the voice recognition module 20 through the network transmission module 242.

After the voice recognition module 20 performs the above operations, a second operating signal S2 corresponding to the second voice command C6 is transmitted from the voice recognition module 20 to the access point 21, and the second operating signal S2 is transmitted from the access point 21 to the electronic device 22 in the kitchen. Consequently, the electronic device 22 is operated according to the second operating signal S2. That is, the electronic device 22 is operated to turn on the air conditioner. According to the technology of the present invention, the second user Y in the living room can operate the electronic device 22 in the kitchen through the digital voice assistant module 24.

The following two aspects should be specially described. Firstly, the operating capability of the first voice recognition unit 245 in the digital voice assistant module 24 is stronger than the operating capability of the second voice recognition unit 232 in the audio device 23. That is, the second voice recognition unit 232 is a low-level voice recognition chip. Consequently, the audio device 23 is cost-effective. Moreover, since the digital voice assistant module 24 is capable of playing music through the first speaker 246, it is preferred that the first voice recognition unit 245 has stronger operating capability to recognize the second wake-up command C5 among the sound of the music. It is noted that the digital voice assistant module is not restricted to have stronger operating capability. In some embodiments, the first voice recognition unit is a low-level voice recognition chip as long as the operation of the first voice recognition unit is feasible.

Secondly, the digital voice assistant operation system may be modified according to the practical requirements. For example, in another embodiment, the digital voice assistant operation system is connected with a monitoring module (not shown) via the access point through network connection. Moreover, the monitoring module is connected with the electronic device via the access point through network connection. The electronic device may report the operating state to the monitoring module at any time. Consequently, if the electronic device is turned on and the operating state is changed, the electronic device will notify the monitoring module. Moreover, the monitoring module may notify the digital voice assistant module through the access point. Consequently, the first speaker of the digital voice assistant module outputs a feedback prompt sound. According to the feedback prompt sound, the second user realizes that the electronic device has been turned on. Similarly, the monitoring module may notify the audio device through the access point and the digital voice assistant module. Consequently, the second speaker of the audio device also outputs a feedback prompt sound. According to the feedback prompt sound, the first user realizes that the electronic device has been turned on.

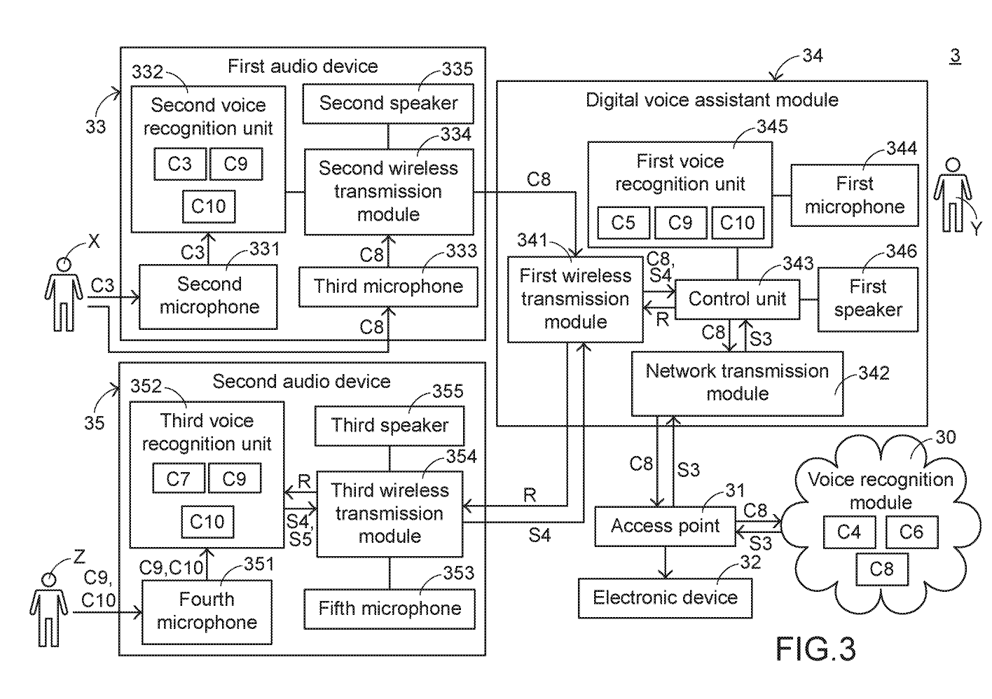

The present invention further provides a second embodiment, which is distinguished from the first embodiment. FIG. 3 is a schematic functional block diagram illustrating the architecture of a digital voice assistant operation system according to a second embodiment of the present invention. As shown in FIG. 3, the digital voice assistant operation system 3 comprises an access point 31, an electronic device 32, a first audio device 33, a digital voice assistant module 34 and a second audio device 35. The access point 31 is in communication with a voice recognition module 30 through network connection. The voice recognition module 30 is installed in a server of the internet. The electronic device 32 is in communication with the access point 31 through network connection. The first audio device 33 is in communication with the digital voice assistant module 34 in a wireless transmission manner. The first audio device 33 is used for receiving a voice command from the user and transmitting the voice command to the digital voice assistant module 34. The second audio device 35 is also in communication with the digital voice assistant module 34 in a wireless transmission manner. The second audio device 35 is used for receiving a voice command from the user and transmitting the voice command to the digital voice assistant module 34. The digital voice assistant module 34 is in communication with the first audio device 33 and the second audio device 35 in a wireless transmission manner and in communication with the access point 31 through network connection. For example, the access point 31 and the digital voice assistant module 34 are installed in the living room, the access point 31 is a network router or a network base station, the first audio device 33 is installed in the bedroom, the electronic device 32 and the second audio device 35 are installed in the kitchen, and the electronic device 32 is an intelligent air conditioner.

The digital voice assistant module 34 comprises a first wireless transmission module 341, a network transmission module 342, a control unit 343, a first microphone 344, a first voice recognition unit 345 and a first speaker 346. The structures and functions of the components of the digital voice assistant module 34 are similar to those of the digital voice assistant module 24 of the first embodiment, and are not redundantly described herein. A default second wake-up command C5 “Wake Up”, a default first response command C9 “Answer” and a default second response command C10 “Hang Up” are stored in the first voice recognition unit 345.

The first audio device 33 comprises a second microphone 331, a second voice recognition unit 332, a third microphone 333, a second wireless transmission module 334 and a second speaker 335. The structures and functions of the components of the first audio device 33 are similar to those of the audio device 23 of the first embodiment, and are not redundantly described herein. A default first wake-up command C3 “Wake Up”, the default first response command C9 “Answer” and the default second response command C10 “Hang Up” are stored in the second voice recognition unit 332.

Similarly, the second audio device 35 comprises a fourth microphone 351, a third voice recognition unit 352, a fifth microphone 353, a third wireless transmission module 354 and a third speaker 355. The structures and functions of the components of the second audio device 35 are similar to those of the first audio device 33, and are not redundantly described herein. A default third wake-up command C7 “Wake Up”, the default first response command C9 “Answer” and the default second response command C10 “Hang Up” are stored in the third voice recognition unit 352. The operations in response to the first response command C9 and the second response command C10 will be described later. Moreover, the first wireless transmission module 341 and the second wireless transmission module 334 are in wireless communication with each other through a digital enhanced cordless telecommunications technology, and the first wireless transmission module 341 and the third wireless transmission module 354 are in wireless communication with each other through the digital enhanced cordless telecommunications technology.

The operations of the digital voice assistant operation system 3 of the present invention will be described as follows. If the first user X in the bedroom intends to make a call with a third user Z in the kitchen, the digital voice assistant operation system 3 can be used to achieve this purpose. Firstly, the digital voice assistant module 34, the first audio device 33 and the second audio device 35 are in a hibernation mode. When the first user X says the first wake-up command C3 “Wake Up” to the first audio device 33, the second microphone 331 receives the first wake-up command C3 and transmits the first wake-up command C3 to the second voice recognition unit 332. Meanwhile, the second voice recognition unit 332 recognizes that the first wake-up command C3 matches the default first wake-up command “Wake Up”. After the recognition is completed, the second voice recognition unit 332 judges that the voice “Wake Up” from the first user X is the first wake-up command C3. Consequently, the first audio device 33 is wakened up from the hibernation mode, and the first audio device 33 is enabled.

After the first audio device 33 is enabled, the first user X may say the third voice command C8 “Call the second audio device” to the first audio device 33. Consequently, the second microphone 331 receives the third voice command C8 and transmits the third voice command C8 to the second voice recognition unit 332. Since the second voice recognition unit 332 is unable to recognize the content of the third voice command C8, the second voice recognition unit 332 does not respond to the third voice command C8. After the second wireless transmission module 334 of the first audio device 33 is wakened up, the third voice command C8 can be transmitted to the second wireless transmission module 334 through the third microphone 333.

After the second wireless transmission module 334 receives the third voice command C8, the second wireless transmission module 334 is in wireless communication with the first wireless transmission module 341 of the digital voice assistant module 34. Consequently, the subsequent wireless transmission can be maintained. Meanwhile, the digital voice assistant module 34 is wakened up by the first wireless transmission module 341.

Then, the third voice command C8 is transmitted from the second wireless transmission module 334 to the first wireless transmission module 341 in a wireless transmission manner. After the third voice command C8 is received by the first wireless transmission module 341, the third voice command C8 is transmitted from the control unit 343 to the voice recognition module 30 of the internet through the access point 31 in a network transmission manner.

After the voice recognition module 30 performs the above operations to recognize the third voice command C8, a third operating signal S3 corresponding to the third voice command C8 is transmitted from the voice recognition module 30 to the access point 31, and the third operating signal S3 is transmitted from the access point 31 to the digital voice assistant module 34. According to the third operating signal S3, the control unit 343 issues a call request R. The call request R is wirelessly transmitted to the second audio device 35 in the kitchen through the first wireless transmission module 341 and the third wireless transmission module 354.

After the third wireless transmission module 354 of the second audio device 35 receives the call request R, the third wireless transmission module 354 controls the third speaker 355 to output a notification sound corresponding to the call request R. For example, the notification sound is phone ring sound. Consequently, the notification sound can be heard by the third user Z in the kitchen. After the third user Z hears the notification sound, the third user Z may say the first response command C9 “Answer” or the second response command C10 “Hang Up”.

If the third user Z says the second response command C10 “Hang Up”, the second response command C10 is transmitted to the third voice recognition unit 352 through the fourth microphone 351. After the third voice recognition unit 352 recognizes the second response command C10, the third voice recognition unit 352 generates a second response signal S5 corresponding to the second response command C10. According to the second response signal S5, the second device 35 does not receive the call request R from the digital voice assistant module 34.

Whereas, if the third user Z says the first response command C9 “Answer” after hearing the notification sound, the first response command C9 is transmitted to the third voice recognition unit 352 through the fourth microphone 351. After the third voice recognition unit 352 recognizes the first response command C9, the third voice recognition unit 352 generates a first response signal S4 corresponding to the first response command C9. Moreover, the first response signal S4 is wirelessly transmitted from the third wireless transmission module 354 to the first wireless transmission module 341. After the control unit 343 receives the first response signal S4, the voice call communication between the second wireless transmission module 334 and the third wireless transmission module 354 is established through the first wireless transmission module 341. Consequently, the first user X and the third user Z can make a call through the first audio device 33 and the second audio device 35. If the third user Z intends to end the call, the third user Z only needs to say the second response command C10 “Hang Up”. According to the second response command C10, the second audio device 35 performs the corresponding operation to end the call. The way of using the first audio device 33 and the second audio device 35 to make a call by the first user X is similar to that mentioned above, and is not redundantly described herein.

The following two aspects should be specially described. Firstly, the second audio device is further comprises a hang-up key. The third user may press the hang-up key to end the call. The arrangement of the hang-up key has two advantages. In accordance with the first advantage, it is not necessary to previously store the second response command “Hang Up” in the third voice recognition unit. Consequently, a low-cost voice recognition chip may be used as the third voice recognition unit to achieve the cost-effective benefit. In accordance with the second advantage, the third voice recognition unit may end the call according to the second response command when the third user does not intend to end the call. For example, if the third user says “hang up” during the call but the third user does not intend to end the call, the third voice recognition unit will end the call and perplex the user. The arrangement of the hang-up key can solve the above problem.

Secondly, the technology of the present invention is not restricted to the call communication between the first audio device 33 and the second audio device 35. As shown in FIG. 3, the first response command C9 “Answer” and the second response command C10 “Hang Up” are also previously stored in the first voice recognition unit 345. Consequently, the first user X may use the first audio device 33 to make a call to the digital voice assistant module 34. Similarly, the third user Z may use the second audio device 35 to make a call to the digital voice assistant module 34. The call communication between the first audio device 33 and the digital voice assistant module 34 and the call communication between the second audio device 35 and the digital voice assistant module 34 are similar to the call communication between the first audio device 33 and the second audio device 35, and thus the detailed descriptions thereof are omitted. Similarly, the second user Y may use the digital voice assistant module 34 to make a call to the first audio device 33 or the second audio device 35. The operations are similar to those mentioned above, and are not redundantly described herein.

From the above descriptions, the present invention provides a digital voice assistant operation system. The digital voice assistant operation system can be applied to a digital family. In accordance with the present invention, plural audio devices are installed in different rooms and the plural audio devices are in wireless communication with a digital voice assistant module. The user may provide the voice command to the audio device in a voice transmission manner. According to the voice command, the audio device and the digital voice assistant module are in wireless communication with each other to perform the associated operations. Consequently, the electronic device in a different room can be controlled, or the plural audio devices in different rooms can make voice calls between each other. When compared with the conventional technology, the digital voice assistant operation system of the present invention is cost-effective because the plural digital voice assistant modules used in the conventional operation system are replaced by the plural low-cost audio devices. That is, only one digital voice assistant module is sufficient to control the electronic device according to the technology of the present invention. In other words, the digital voice assistant operation system is effective to solve the drawbacks of the conventional technologies.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A digital voice assistant operation system in communication with a voice recognition module through network connection, the digital voice assistant operation system comprising:
an access point in communication with the voice recognition module through network connection;
an electronic device in communication with the access point through network connection;
an audio device receiving a first voice command and outputting the first voice command; and
a digital voice assistant module in wireless communication with the audio device and in communication with the access point through network connection, wherein the digital voice assistant module comprises:
a first wireless transmission module in wireless communication with the audio device, and receiving the first voice command;
a network transmission module in communication with the access point through network connection, and transmitting the first voice command; and
a control unit connected with the network transmission module, wherein after the control unit receives the first voice command, the control unit controls the network transmission module to transmit the first voice command, and the control unit transmits the first voice command to the voice recognition module through the access point, wherein after the voice recognition module recognizes the first voice command, a first operating signal corresponding to the first voice command is outputted from the voice recognition module to the electronic device through the access point, so that the electronic device performs an operation according to the first operating signal.

2. The digital voice assistant operation system according to claim 1, wherein the audio device comprises:
a first microphone receiving a first wake-up command;
a low-level voice recognition unit connected with the first microphone to recognize the first wake-up command, wherein after the low-level voice recognition unit recognizes the first wake-up command, the audio device is wakened up from a hibernation mode by the low-level voice recognition unit;
a second microphone receiving the first voice command; and
a second wireless transmission module connected with the second microphone and in wireless communication with the first wireless transmission module, wherein the first voice command is wirelessly transmitted from the second wireless transmission module to the first wireless transmission module.

3. The digital voice assistant operation system according to claim 2, wherein the digital voice assistant module further comprises:
a third microphone receiving a second voice command and a second wake-up command; and
a voice recognition unit connected with the third microphone to recognize the second wake-up command, wherein after the voice recognition unit recognizes the second wake-up command, the digital voice assistant module is wakened up from a hibernation mode by the voice recognition unit, wherein the digital voice assistant module transmits the second voice command to the voice recognition module through the network transmission module, wherein after the voice recognition module recognizes the second voice command, a second operating signal corresponding to the second voice command is outputted from the voice recognition module to the electronic device through the access point, so that the electronic device performs an operation according to the second operating signal.

4. The digital voice assistant operation system according to claim 3, wherein after the third microphone receives a third voice command, the control unit transmits the third voice command to the voice recognition module through the network transmission module, wherein after the voice recognition module recognizes the third voice command, a third operating signal corresponding to the third voice command is outputted from the voice recognition module to the digital voice assistant module and the control unit issues a call request to the audio device according to the third operating signal, wherein after the first wireless transmission module receives a response signal from the audio device, the control unit establishes call communication between the digital voice assistant module and the audio device according to the response signal.

5. The digital voice assistant operation system according to claim 3, wherein after the second microphone receives a third voice command, the second wireless transmission module transmits the third voice command to the first wireless transmission module in a wireless transmission manner, and the control unit transmits the third voice command to the voice recognition module through the network transmission module, wherein after the voice recognition module recognizes the third voice command, a third operating signal corresponding to the third voice command is outputted from the voice recognition module to the digital voice assistant module.

6. The digital voice assistant operation system according to claim 5, wherein the control unit controls a second speaker of the digital voice assistant module to generate a notification sound according to the third operating signal, wherein after the third microphone receives a response command and the voice recognition unit recognizes the response command, the voice recognition unit generates a response signal corresponding to the response command, and the control unit establishes call communication between the digital voice assistant module and the audio device according to the response signal.

7. The digital voice assistant operation system according to claim 2, wherein the audio device further comprises a first speaker, wherein the first speaker is connected with the second wireless transmission module, and the first speaker outputs a feedback sound when the electronic device performs the operation.

8. The digital voice assistant operation system according to claim 2, wherein the digital voice assistant module further comprises a second speaker, wherein the second speaker is connected with the control units, and the second speaker outputs a feedback sound when the electronic device performs the operation.

9. A digital voice assistant operation system in communication with a voice recognition module through network connection, the digital voice assistant operation system comprising:
an access point in communication with the voice recognition module through network connection;
a first audio device receiving a voice command and outputting the first voice command;
a digital voice assistant module in wireless communication with the first audio device and in communication with the access point through network connection, wherein the digital voice assistant module comprises:
a first wireless transmission module in wireless communication with the first audio device, and receiving the first voice command;
a network transmission module in communication with the access point through network connection, and transmitting the first voice command, wherein the voice command is transmitted to the voice recognition module through the access point, wherein after the voice recognition module recognizes the voice command, an operating signal corresponding to the voice command is outputted from the voice recognition module; and
a control unit connected with the network transmission module, wherein the control unit issues a call request according to the operating signal; and
a second audio device in wireless communication with the first wireless transmission module, wherein the second audio device receives the call request and generates a response signal corresponding to the call request, wherein the control unit establishes call communication between the first audio device and the second audio device according to the response signal.

10. The digital voice assistant operation system according to claim 9, wherein the first audio device comprises:
a first microphone receiving a wake-up command;
a first voice recognition unit connected with the first microphone to recognize the wake-up command, wherein after the first voice recognition unit recognizes the wake-up command, the first audio device is wakened up from a hibernation mode by the first recognition unit;
a second microphone receiving the voice command; and
a second wireless transmission module connected with the second microphone and in wireless communication with the first wireless transmission module and the second audio device, wherein the voice command is wirelessly transmitted from the second wireless transmission module.

11. The digital voice assistant operation system according to claim 10, wherein the second audio device comprises:
a third microphone receiving a response command corresponding to the call request;
a speaker, wherein after the third microphone receives the call request, the speaker outputs a notification sound corresponding to the call request;
a second voice recognition unit connected with the third microphone to recognize the response command, wherein after the second voice recognition unit recognizes the response command, the second audio device generates the response signal corresponding to the response command; and
a third wireless transmission module connected with the speaker and in wireless communication with the first wireless transmission module and the first audio device, wherein the call request and the response command are wirelessly transmitted from the third wireless transmission module.

12. The digital voice assistant operation system according to claim 11, wherein after the third microphone receives the response command and the second voice recognition unit recognizes the response command, the response signal corresponding to the response command is transmitted from the third wireless transmission module to the first wireless transmission module.

13. The digital voice assistant operation system according to claim 11, wherein the first wireless transmission module, the second wireless transmission module and the third wireless transmission module are in wireless communication with each other through a digital enhanced cordless telecommunications technology.
